(19) United States
(12) Patent Application Publication
(10) Pub. No.: US 2006/0171105 A1
(43) Pub. Date: Aug. 3, 2006

(54) Monitor auto-adjustment system

(76) Inventor: Wen-Tsung Hsiao, Taipei (TW)

Correspondence Address: Wen-Tsung Hsiao, P.O. Box 44-2049, Taipei, 10668, TW

(21) Appl. No.: 11/044,167

(22) Filed: Jan. 28, 2005

(51) Int. Cl. G06F 1/16

(52) U.S. Cl. 361/681; 248/917

(57) ABSTRACT

A monitor auto-adjustment system comprises a lifting mechanism and an adjusting mechanism which each links separately to a power unit. The power unit linking to the lifting mechanism is used for moving a sleeve vertically and the other linking to the adjusting mechanism is used for adjusting the pitch angle by means of using a driven-gear to drive a toothlike adjuster installed on a brace connected to a monitor. The power unit drives a gear to accomplish the adjustment of the height and pitch angle of a monitor automatically. The monitor auto-adjustment system improves the convenience and utility much more than any existing manually adjusted monitor.

### BACKGROUND OF THE INVENTION

1. Field of the Invention

This invention relates to a monitor auto-adjustment system and more particularly to a driven-gear driven by a power unit for lifting a monitor or for adjusting the pitch angle of the monitor to increase the utility and the economic benefits much more than a manually adjusted monitor.

2. Description of the Prior Art

Referring to FIG. 1, an existing table monitor comprises a supporter 1 and a monitor 2. As the height difference between an user's sitting posture and a table monitor 2 is caused by different user's stature and is easily causing the user's visual fatigue, it is necessary to adjust the height difference by putting the monitor 2 on a higher or lower table just because that the supporter 1 of the monitor 2 is fixed and not able to stretch. This situation causes users a lot of inconvenience.

Furthermore, as a user can not see the monitor 2 clearly due to bad visual angle, it is necessary to adjust the pitch angle by manually pushing the backside of the monitor 2. This manual action could damage the panel of the monitor 2 if users push too hard or even to jeopardize themselves because of circuit leakage caused by the damage of the monitor 2.

Therefore, considering of the defects and the inconvenience of the existing monitor mentioned as above, this invention is created to increase the value and the range of substantial utility by inventor's professional knowledge and spirit of pursuing innovation and perfecting.

### SUMMARY OF THE INVENTION

The monitor auto-adjustment system comprises a lifting mechanism and an adjusting mechanism. The lifting mechanism contains a pivot bolt edged with a gear driven by a power-gear. The pivot bolt has a middle hole penetrated with a shaft and fixed by a nut. The shaft links a screw extrusion pierced through a sleeve which join the nut tightly. The power-gear is installed on the outside edge of a housing placed under the nut. The housing fixed on a bracket contains the pivot bolt, gear and shaft. About the adjusting mechanism, it contains a base above the sleeve. And both sides of the base are set correspondingly with a left gearbox and a right gearbox. A driven-gear is set on the left gearbox. And a brace is set between the front sides of the left gearbox and the right gearbox. A toothlike adjuster is stretched from the backside of the brace and is driven by the driven-gear.

And both the lifting mechanism and the adjusting mechanism link a power unit each. The power-gear of the lifting mechanism leads the gear of the pivot bolt to operate and makes the screw extrusion on the shaft spin. And then the sleeve tightened on the nut moves vertically on the screw extrusion. This accomplishes the purpose to adjust the height of a monitor. Moreover, the power-gear of the adjusting mechanism leads the toothlike-gear on the brace linked with a monitor to operate. It accomplishes the purpose to adjust the pitch angle of the brace of a monitor.

The principal objects of this invention is to improve the convenience and utility much more than ever by using the power unit to drive the driven-gear each on the lifting mechanism and the adjusting mechanism to adjust the height and the pitch angle of monitor automatically.

### BRIEF DESCRIPTION OF THE DRAWINGS

FIG. 1 is a rear elevational view of a prior art monitor;

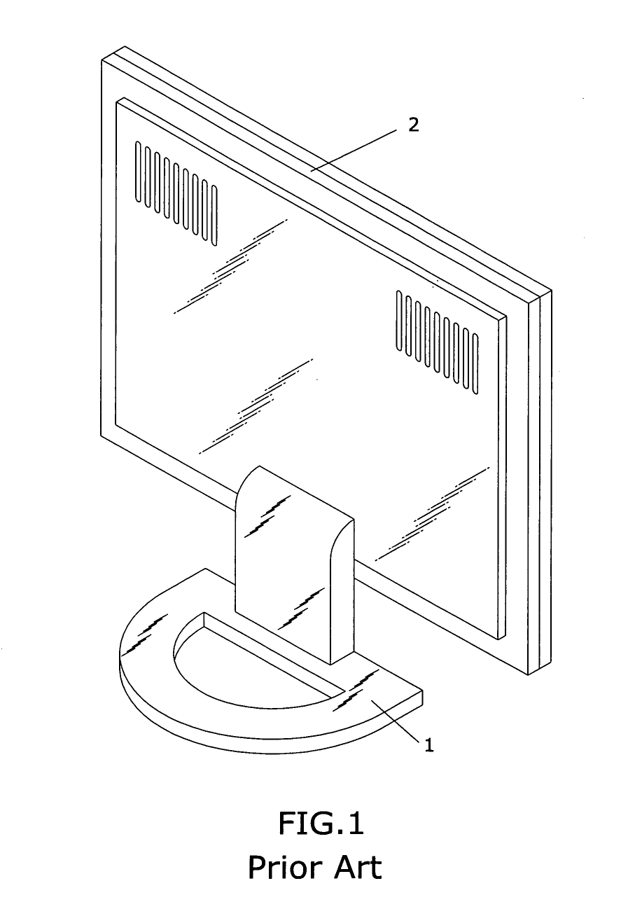

FIG. 2 is an exploded perspective view of lifting mechanism of a preferred embodiment of the present invention;

FIG. 3 is an exploded perspective view of adjusting mechanism of a preferred embodiment of the present invention;

FIG. 4 is an assembly perspective view of FIG. 2 and FIG. 3;

FIG. 5 is a cross-sectional view of a preferred embodiment of the present invention;

FIG. 6 illustrates the preferred embodiment of the present invention of FIG. 5 in an operating position thereof.

### DESCRIPTION OF THE PREFERRED EMBODIMENTS

This invention comprises a lifting mechanism 3, an adjusting mechanism 4, two power units 5 and a plate 6.

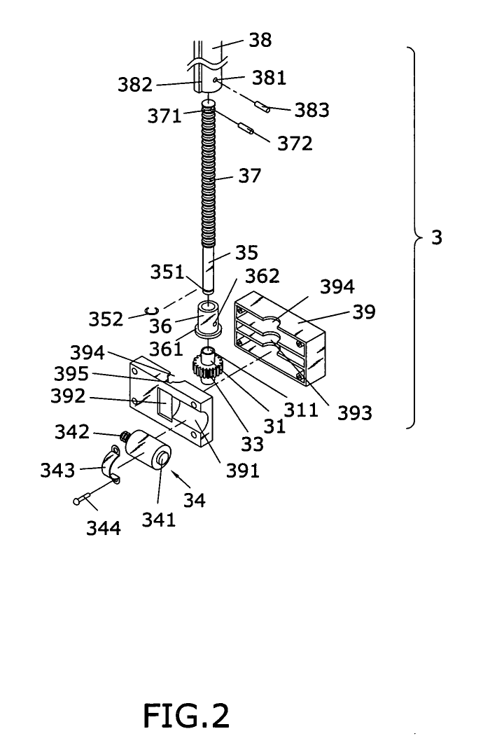

Referring to FIG. 2, the lifting mechanism 3 contains a pivot bolt 31 with a gear 33 driven by a power-gear 34. The pivot bolt 31 has a middle hole 311 penetrated with a shaft 35 and fixed by a nut 36. The shaft 35 links a screw extrusion 37 piercing through a sleeve 38 and joining the nut 36 tightly. The power-gear 34 is installed on outside edge of a housing 39 and is placed under the nut 36. The housing 39 contains the pivot bolt 31, gear 33 and shaft 35 and is fixed on a bracket 32.

A penetrated-hole 371 pieced with a latch 372 is set on proper place of the screw extrusion 37 for avoiding the nut 36 to escape from the end of the screw extrusion 37. The power-gear 34 comprises a motor 341 and a thread-gear 342 which both are fixed on a socket 391 and an opening 392 on outside edge of the housing 39 by a fixing-piece 343 and a bolt 344. A containing room 393 of the housing 39 is corresponding to the opening 392 for setting the gear 33 to engage the thread-gear 342. A joined-opening 394 and a U-type opening 395 are set on adjacent sides of the housing 39 for clipping one end of the shaft 35. On this end of the shaft 35, a ring 351 is set hollowly on proper position and clipped by a fastener 352 for being joined tightly inside the pivot bolt 31 to avoid the separation of the shaft 35 during operation.

A ring-edge 361 is stretched from one end of the nut 36 and is engaged on the joined-opening 394 of the housing 39. And a U-type piece 382 is stretched from one end of the sleeve 38 and is engaged on the U-type opening 395 of the joined-opening 394. An aperture 362 perforated on proper place of the ring-edge 361 and a sleeve-hole 381 perforated on one side of the sleeve 38 are corresponding tightly and are fixed alternatively by a latch 383 or a bolt.

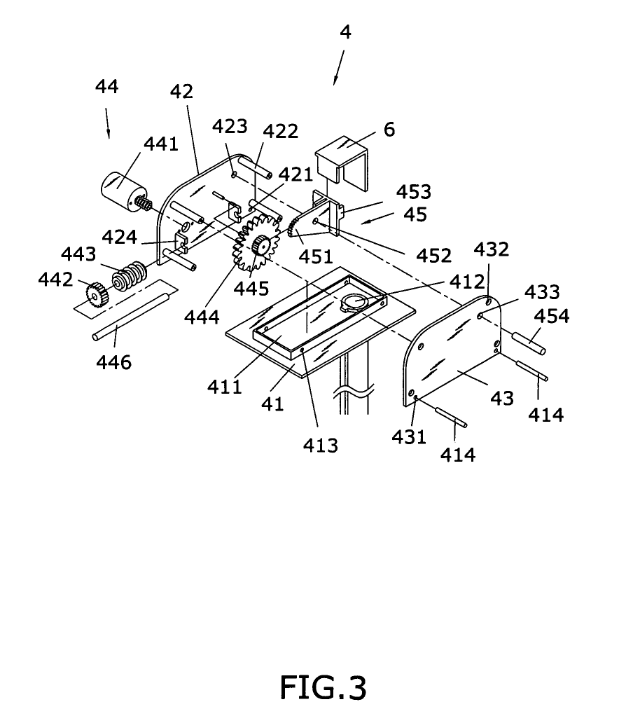

Referring to FIG. 3, the adjusting mechanism 4 has a base 41 mounted on one end of the sleeve 38. And a left gearbox 42 and a right gearbox 43 are set correspondingly inside the base 41. A driven-gear 44 is set on the left gearbox 42. And a brace 45 is set between one sides of the left gearbox 42 and the right gearbox 43. A toothlike adjuster 451 is stretched from one side of the brace 45 and is driven by the driven-gear 44.

A placing-part 411 is set on the base 41 for containing the left gearbox 42, the right gearbox 43 and the driven-gear 44. And a joined-part 412 fixed one end of the sleeve 38 is set on one side of the placing-part 411. Near the sides of the left gearbox 42 and the right gearbox 43, several fixed-holes 413 are placed and corresponding to those holes 421, 431 on the left gearbox 42 and the right gearbox 43 by latches 414. A pole 422 on each corner of the left gearbox 42 is joined corresponding to a fixed-hole 432 on each corner of the right gearbox 43 by bolts.

A pivot-hole 452 is set on the toothlike adjuster 451 of the brace 45 and is joined correspondingly with a pivot-hole 423 on the left gearbox 42 and a pivot-hole 433 on the right gearbox 43 through a pivot 454. A prominence 453 is set on each opposite side of the brace 45 for joining the plate 6 which connects to a monitor.

The driven-gear 44 contains a motor thread-gear 441, a small-gear 442, a thread-gear 443, a mother-gear 444, a child-gear 445 and a gear axle 446. The motor thread-gear 441, the mother-gear 444, the child-gear 445 and the gear axle 446 are set on the left gearbox 42. And the small-gear 442 and the thread-gear 443 are penetrated by the gear axle 446. Each end of the gear axle 446 is fixed by a clip 424 set on the side near the brace 45 of the left gearbox 42.

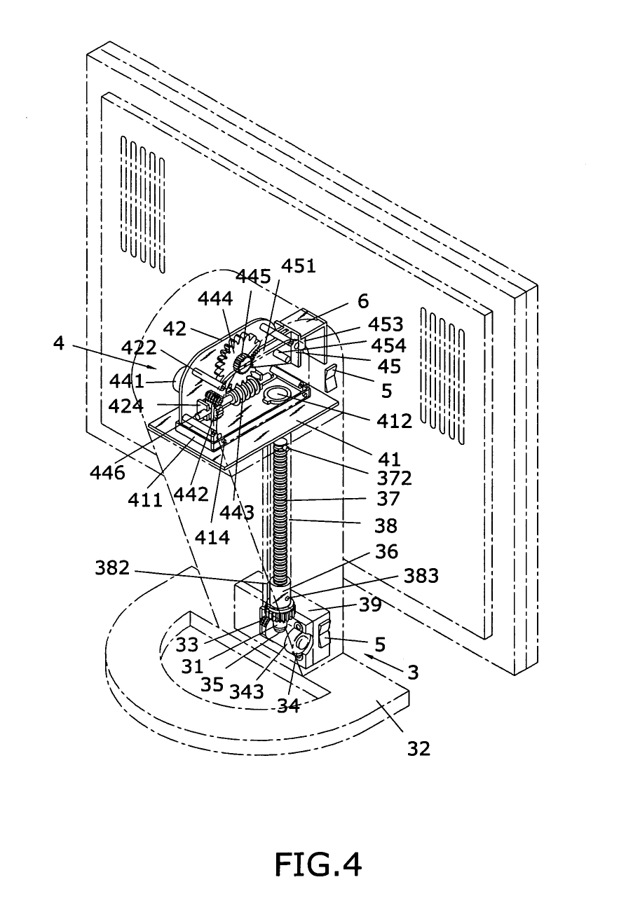

Referring to FIG. 4, the lifting mechanism 3 and the adjusting mechanism 4 link to the power unit 5 each independently. The power-gear 34 of the lifting mechanism 3 leads the gear 33 on the pivot bolt 31 to operate and makes the screw extrusion 37 joined with the shaft 35 to spin, then to make the nut 36 joined with the sleeve 38 move vertically along the screw extrusion 37. It achieves the purpose to adjust the height of monitor 2. And the power-gear 44 of the adjusting mechanism 4 leads the toothlike-gear 451 of the brace 45 joined with the monitor-connecting plate 6 to operate. It accomplishes the purpose to adjust the pitch angle of the brace 45 and the monitor.

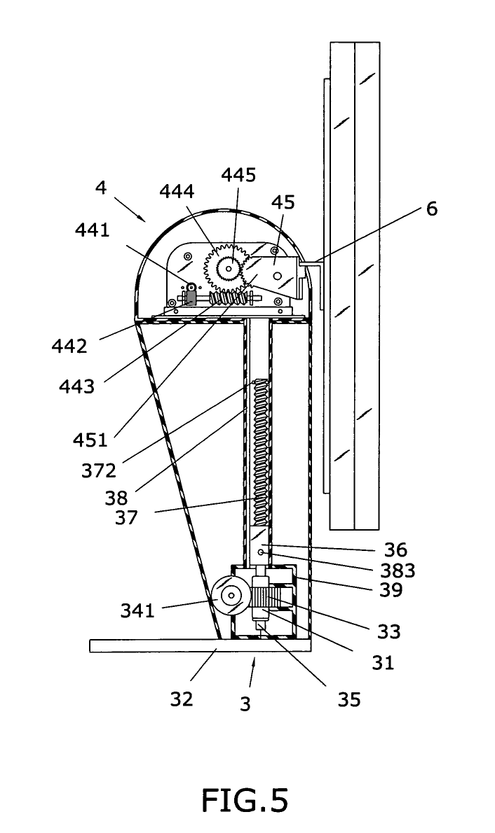

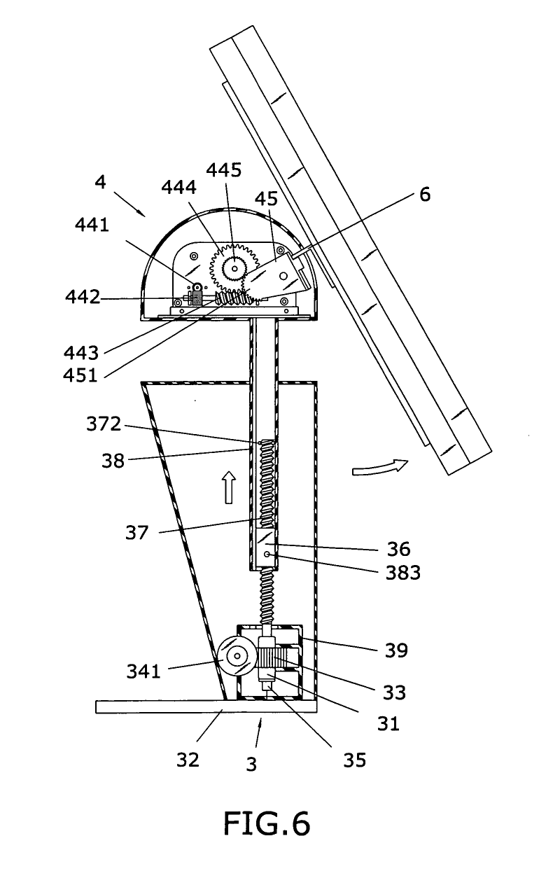

Referring to FIGS. 5 and 6, as the height between an user's sitting posture and a monitor becomes different, usually caused by different user's stature (such as a child or an adult), the user could just push the power unit 5 of the lifting mechanism 3 to make the motor 341 of the power-gear 34 to operate. In the mean time, the thread-gear 342 of the power-gear 34 drives the gear 33, and then the gear 33 drives the screw extrusion 37 fixed on the shaft 35. Because of the limitation of the U-type piece 382 of the sleeve 38 and the U-type opening 395 of the housing 39, the spin movement of the screw extrusion 37 drives the nut 36 and the sleeve 38 only moving vertically but not twirling. So the sleeve 38 tightened with the nut 36 only moves vertically, and the monitor linked to the base 41 moves vertically also.

When a user can not see a monitor clearly due to bad visual angle, the user could just push the power unit 5 of the adjusting mechanism 4 to make the motor thread-gear 441 of the driven-gear 44 to drive the small-gear 442. Then the small-gear 442 drives the small thread-gear 443 to spin. This spin movement causes the mother-gear 444 to operate. In the mean time, the child-gear 445 on the mother-gear 444 is rotated to actuate the toothlike adjuster 451 of the brace 45 connected a monitor through the plate 6. Then the pitch angle of the monitor could be adjusted automatically.

To sum up the above descriptions, what using power unit 5 to drive the driven-gears 34 and 44 on the lifting mechanism 3 and the adjusting mechanism 4 can control the height and the pitch angle of a monitor without manual labor. So this invention indeed improves the convenience and utility much more than ever.

Obviously the invention is susceptible to changes or alternations without defeating its practicability. Therefore, the preferred embodiment shown in the drawings and described herein is not confined.

What is claimed is:

1. A monitor auto-adjustment system comprising:
a lifting mechanism having a pivot bolt with a gear driven by a power-gear and with a middle hole for fixing a shaft by a nut and having a power-gear on a housing fixed on a bracket,
said shaft linking to a screw extrusion pieced through a sleeve,
said housing containing said pivot, said gear and said shaft;
an adjusting mechanism having a base with a left gearbox and a right gearbox on the opposite side each of the base and having a driven-gear to drive a toothlike adjuster on said brace,
said base being set on one end of said sleeve,
said left gearbox and said right gearbox being mutual corresponding,
said driven-gear being contained in said left gearbox,
said brace being set between said left gearbox and said right gearbox;
a power unit each linking separately to said lifting mechanism and said adjusting mechanism.

2. The monitor auto-adjustment system according to claim 1 and further including:
a penetrated-hole on said screw extrusion with a latch in it.

3. The monitor auto-adjustment system according to claim 1 and further including:
a motor and a thread-gear both set on said power-gear being fixed on a socket and an opening of said housing by a fixing-piece and a bolt,
said thread-gear being engaged to said gear of said pivot bolt;
a containing room in the housing being corresponding to said opening;
a U-type opening and a joined-opening being set on adjacent sides of said housing for clipping one end of said shaft;
a ring being set hollowly on said shaft and being fixed with a fastener.

4. The monitor auto-adjustment system according to claim 1 and further including:
a ring-edge being stretched from one end of said nut to engage on said joined-opening and having an aperture,
said aperture being correspondingly fixed to a sleeve-hole on one end of said sleeve by a latch;
a U-type piece being set on one end of said sleeve and being engaged on a U-type opening of said joined-opening.

5. The monitor auto-adjustment system according to claim 4 and further including:
said aperture being correspondingly fixed to a sleeve-hole on one end of said sleeve by a bolt.

6. The monitor auto-adjustment system according to claim 1 and further including:
a placing-part on said base being used for setting said left gearbox and said right gearbox as well as said driven-gear;
a joined-part fixed one end of said sleeve being set on one side of said placing-part;
each hole being set on said left gearbox and said right gearbox and being correspondingly fixed to a fixed-hole set on both sides of said joined-part by a latch;
each pole of said left gearbox being joined corresponding to said fixed-hole of said right gearbox by a bolt.

7. The monitor auto-adjustment system according to claim 1 and further including:
a pivot-hole being set on said toothlike adjuster and being joined correspondingly to a pivot-hole on said left gearbox and a pivot-hole on said right gearbox by a pivot;
a prominence being set on each opposite side of said brace for joining a plate connected to a monitor.

8. The monitor auto-adjustment system according to claim 1 and further including:
a motor thread-gear, a small-gear, a thread-gear, a mother-gear, a child-gear and a gear axle being set in said driven-gear,
said motor thread-gear, said mother-gear, said child-gear and said gear axle being set on said left gearbox,
said small-gear and said thread-gear being penetrated by said gear axle for fixing;
a clip each being set in said left gearbox and being used to fix each end of said gear axle.
